(19) United States
(12) Patent Application Publication
(10) Pub. No.: US 2026/0346902 A1
(43) Pub. Date: Nov. 5, 2026

(54) DUAL RACK ELECTRIC POWER STEERING SYSTEM FOR VEHICLE

(71) Applicant: Steering Solutions IP Holding Corporation, Saginaw, MI (US)

(72) Inventors: Jacob J. Barber, Auburn, MI (US); Troy M. Kinne, Midland, MI (US); Christopher R. Douglas, Saginaw, MI (US); Brian G. Maust, Unionville, MI (US); Scott Wirth, Grand Blanc, MI (US)

(21) Appl. No.: 19/667,032

(22) Filed: May 4, 2026

Related U.S. Application Data
(60) Provisional application No. 63/799,955, filed on May 5, 2025.

(51) Int. Cl. B62D 3/12; B62D 5/04

(52) U.S. Cl. CPC B62D 3/126; B62D 5/0424

(57) ABSTRACT

A rack bar assembly includes a first rack bar extending axially. The rack bar assembly also includes a second rack bar extending axially, wherein the first rack bar and the second rack bar are spaced a radial distance from each other and oriented parallel to each other. The rack bar assembly further includes a pair of end brackets including a first end bracket and a second end bracket, the first end bracket coupled to a first end of the first rack bar and a first end of the second rack bar, the second end bracket coupled to a second, opposite end of the first rack bar and a second, opposite end of the second rack bar. The rack bar assembly yet further includes a mounting bracket operatively coupled to the pair of end brackets, wherein the mounting bracket includes a pair of tie rod mounting locations.

### CROSS-REFERENCE TO RELATED APPLICATION

This application claims the benefits of priority to U.S Provisional Application Serial No. 63/799,955, filed May 5, 2025, the disclosure of which is incorporated by reference herein in its entirety.

### FIELD OF THE INVENTION

The embodiments described herein relate to vehicle steering systems and, more particularly, to a dual rack electric power steering system.

### BACKGROUND

Steering systems that employ a ball screw to convert rotary steering assist power into a linear output may be referred to as a rack assist electric power steering (REPS) system. A traditional REPS system for automotive applications requires a high load and a long range of translational rack travel (e.g., 75 mm), with both a rack tooth section and a ball screw section on the rack in-line. In other words, the tooth section and the ball screw section are sequentially disposed on the same rack. This tends to require large distances between a pair of inner ball joints, such as greater than 700 mm in some instances.

Some vehicle manufacturing and supplier applications may require a reduced inner ball joint-to-inner ball joint distance, such as below the 700 mm example noted above, but still desire similar rack travel capability. Typically, such an application would exclude use of the traditional style of REPS equipment.

In some vehicles which require specific chassis features such as long suspension travel, narrow chassis designs, or other specific packaging requirements it can be difficult to meet inner ball joint mounting location requirements, while having systems capable of delivering the desired rack forces. Either manual gear or pinion style EPS have been sought to solve packaging issues, but are limited on rack forces that can be delivered through these designs.

### SUMMARY

According to one aspect of the disclosure, a rack bar assembly for a rack electric power steering system includes a first rack bar extending axially. The rack bar assembly also includes a second rack bar extending axially, wherein the first rack bar and the second rack bar are spaced a radial distance from each other and oriented parallel to each other. The rack bar assembly further includes a pair of end brackets including a first end bracket and a second end bracket, the first end bracket coupled to a first end of the first rack bar and a first end of the second rack bar, the second end bracket coupled to a second, opposite end of the first rack bar and a second, opposite end of the second rack bar. The rack bar assembly yet further includes a mounting bracket operatively coupled to the pair of end brackets, wherein the mounting bracket includes a pair of tie rod mounting locations.

According to another aspect of the disclosure, a rack bar assembly for a rack electric power steering system includes a first rack bar extending axially. The rack bar assembly also includes a second rack bar extending axially, wherein the first rack bar and the second rack bar are spaced a radial distance from each other and oriented parallel to each other. The rack bar assembly further includes a mounting bracket directly coupled to at least one of the first rack bar and the second rack bar, wherein the mounting bracket includes a pair of tie rod mounting locations.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a vehicle steering system.

FIG. 2 is a cross-sectional view of a portion of a dual rack electric power steering (DREPS) system.

FIG. 3 is a perspective view of the DREPS system having a mounting bracket structure according to a first aspect of the disclosure.

FIG. 4 is a plan view of the DREPS system having the mounting bracket structure according to another aspect of the disclosure.

### DETAILED DESCRIPTION

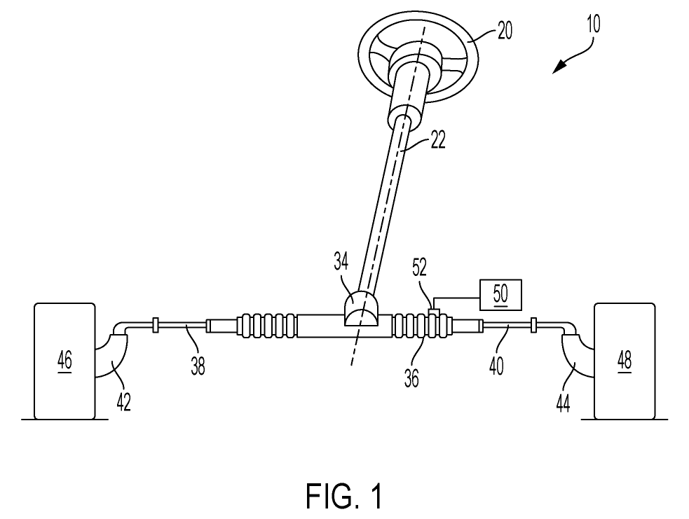

Referring now to the Figures, where the invention will be described with reference to specific embodiments, without limiting same, FIG. 1 illustrates a vehicle steering system 10 that is provided to steer a vehicle in a desired direction. The steering system 10 may include a hand wheel 20 operatively connected to a gear housing 34 via a steering column 22. The steering column 22 may be formed with one or more column sections, such as an upper column and a lower column, for example, but it is to be appreciated that various numbers of column sections may be employed.

The steering system 10 is an electric power steering system that utilizes a rack and pinion steering mechanism, which includes a rack bar assembly 36. The rack bar assembly 36 is only schematically illustrated in FIG. 1. The specific rack bar assembly details of the current disclosure is not shown in FIG. 1. In particular, and as will be appreciated from the disclosure, the rack bar assembly 36 includes a pair of rack bars arranged in parallel. Accordingly, the electric power steering system may be referred to as a dual rack electric power steering (DREPS) system. Also included are tie rods 38, 40, steering knuckles 42, 44, and road wheels 46, 48.

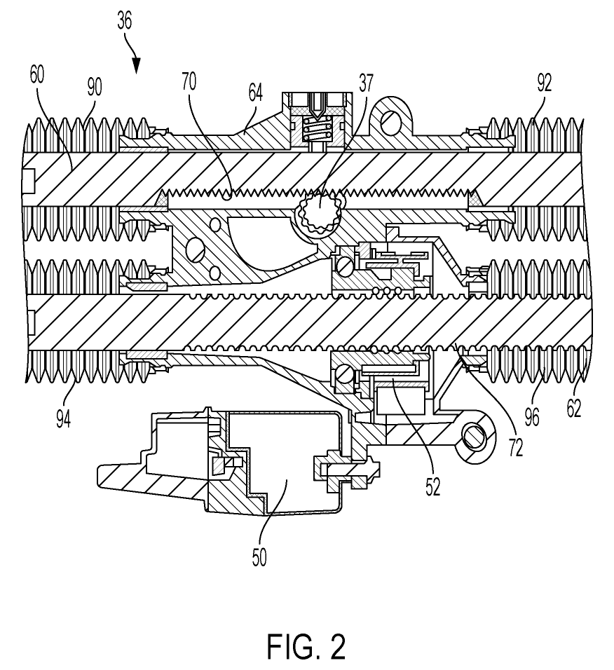

Referring now to FIG. 2, the rack bar assembly 36, and overall DREPS system, is illustrated in greater detail. The rack bar assembly 36 includes a first rack bar 60 and a second rack bar 62. The first rack bar 60 and the second rack bar 62 are oriented substantially parallel to each other, but are radially spaced from each other. In other words, the two rack bars 60, 62 are not axially in-line with each other. The rack bars 60, 62 are of a substantially equal axial length in some embodiments, but their axial length may differ in other embodiments. The first rack bar 60 and the second rack bar 62 are structurally connected to each other with a housing 64. The housing 64 is a single, integrally formed structure in some embodiments. For example, the housing 64 may be a die cast component.

A pinion gear 37 is located under the gear housing 34. The first rack bar 60 includes a toothed region 70 for engagement or connection with the pinion gear 37. During operation, as the hand wheel 20 is turned by a vehicle operator, the steering column 22 turns the pinion gear 37. Rotation of the pinion gear 37 interacts with the toothed region 70 to move the first rack bar 60. Furthermore, in some embodiments a physical connection is not provided between the hand wheel 20 (or other steering input device) and a lower/forward portion of the steering column 22.

The steering system 10 also includes a power steering assist assembly that assists steering effort with a motor 50 that drives a ball-screw assembly, as shown in FIGS. 1 and 2. In particular, a nut 52 is engaged with a ball screw region 72 of the second rack bar 62 to assist with translation of the second rack bar 62. The ball screw region 72 is a region of the second rack bar 62 that includes a ball screw thread form that is kinematically engaged with the nut 52 through a series of balls in a recirculating ball circuit for powered steering assist.

The housing 64 contains at least a portion of the first rack bar 60 and at least a portion of the second rack bar 62, while maintaining a desired radial spacing to arrange the rack bars 60, 62 in the above-described substantially parallel orientation. Each rack bar 60, 62, is surrounded by one or more sealing boots to maintain proper operation of the rack bar assembly 36. For example, a first sealing boot 90 surrounds a portion of the first rack bar 60, a second sealing boot 92 surrounds a portion of the first rack bar 60, a third sealing boot 94 surrounds a portion of the second rack bar 62, and a fourth sealing boot 96 surrounds a portion of the second rack bar 62.

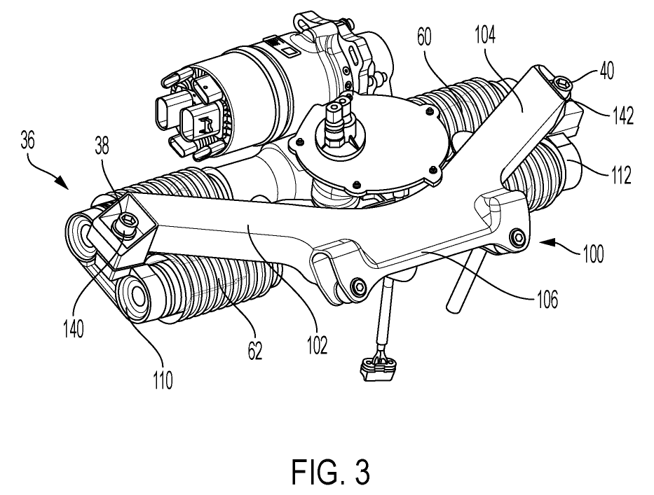

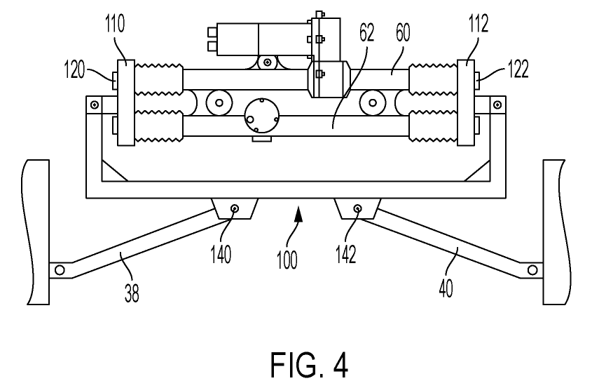

The dual rack electric power steering system described with reference to FIGS. 1 and 2 employs the first rack bar 60 and the second rack bar 62 disposed in parallel to facilitate narrow vehicle packages while providing high rack force capability in a compact package. In the additional aspects described below with reference to FIGS. 3 and 4, a mounting bracket is integrated with the rack bar assembly 36 so that tie rod mounting locations are not constrained to be located directly at ends of the rack bars 60, 62.

Referring now to FIG. 3, the DREPS system includes a mounting bracket 100 integrated with the rack bar assembly 36 and configured to receive one or both of the tie rods 38, 40 via tie rod mounting locations 140, 142. The tie rod mounting locations 140, 142 may be holes configured to receive end features of the tie rods in a coupling manner. In some embodiments, the mounting bracket 100 includes a first bracket leg 102 and a second bracket leg 104. The first bracket leg 102 and the second bracket leg 104 can extend from a central portion 106 of the mounting bracket 100 toward opposite sides of the rack bar assembly 36 to position tie rod mounting features 140, 142 at desired locations relative to the first rack bar 60 and the second rack bar 62. In some embodiments, the first bracket leg 102 and the second bracket leg 104 are angled relative to each other. For example, the first bracket leg 102 and the second bracket leg 104 can be oriented at a non-parallel and non-perpendicular angle relative to each other.

In some embodiments, the mounting bracket 100 encompasses and mounts to end portions of the first rack bar 60 and the second rack bar 62. In some embodiments, the mounting bracket 100 is coupled directly to the first rack bar 60 and the second rack bar 62. In other embodiments, the mounting bracket 100 is coupled to the rack bar assembly 36 through a first end bracket 110, a second end bracket 112, or both the first end bracket 110 and the second end bracket 112. The first end bracket 110 and the second end bracket 112 are each configured to couple the mounting bracket 100 to one or both of the first rack bar 60 and the second rack bar 62 at corresponding end regions of the rack bar assembly 36.

Referring now to FIG. 4, in some embodiments the first end bracket 110 is disposed adjacent a first axial end 120 of the rack bar assembly 36 and the second end bracket 112 is disposed adjacent an opposite axial end region 122 of the rack bar assembly 36. The mounting bracket 100 can extend between the first end bracket 110 and the second end bracket 112 so that the mounting bracket 100 is supported by both rack bars 60, 62 through the first end bracket 110 and the second end bracket 112. In other embodiments, one of the first end bracket 110 and the second end bracket 112 may be omitted such that the mounting bracket 100 is supported at one end region of the rack bar assembly 36 while remaining coupled to the first rack bar 60 and the second rack bar 62 at another location. The disclosed arrangement thereby permits one end bracket and two end bracket implementations. In the embodiment of FIG. 4, the mounting bracket 100 includes a main portion 130 extending approximately in a cross-car direction. A first bracket portion 132 extends from the main portion 130 toward the rack bar assembly 36. Similarly, a second bracket portion 134 extends from the main portion 130 toward the rack bar assembly 36. Each of the first and second bracket portions 132, 134 may extend substantially perpendicularly to the main portion 130, or at any other non-parallel angle relative to the main portion 130. The first and second bracket portions 132, 134 may be operatively coupled to the rack bar assembly 36 via the end brackets 110, 112 or directly thereto.

In the embodiment of FIG. 4, the mounting bracket 100 includes one or more tie rod mounting features 140, 142 located inwardly relative to the end locations of the first rack bar 60 and the second rack bar 62 so that the inner ball joint mounting location can be moved in space relative to the rack bar end location and, in some embodiments, relative to the location of the electric power steering gear within the vehicle. By coupling the tie rods 38, 40 directly to the mounting bracket 100, the inner tie rod-to-inner tie rod mounting distance can be selected with increased flexibility to better align with vehicle packaging and chassis requirements. The mounting bracket arrangement can be employed while the first rack bar 60 continues to receive steering input through engagement of the pinion gear 37 with the toothed region 70 and while the second rack bar 62 continues to receive steering assist through the nut 52 engaged with the ball screw region 72, thereby preserving the force capability of the dual rack architecture while providing increased freedom in positioning the tie rods 38, 40 relative to the rack bar assembly 36.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A rack bar assembly for a rack electric power steering system, the rack bar assembly comprising:
a first rack bar extending axially;
a second rack bar extending axially, wherein the first rack bar and the second rack bar are spaced a radial distance from each other and oriented parallel to each other;
a pair of end brackets including a first end bracket and a second end bracket, the first end bracket coupled to a first end of the first rack bar and a first end of the second rack bar, the second end bracket coupled to a second, opposite end of the first rack bar and a second, opposite end of the second rack bar; and
a mounting bracket operatively coupled to the pair of end brackets, wherein the mounting bracket includes a pair of tie rod mounting locations.

2. The rack bar assembly of claim 1, further comprising a housing containing at least a portion of the first rack bar and at least a portion of the second rack bar, the housing maintaining the radial distance between the first rack bar and the second rack bar.

3. The rack bar assembly of claim 1, wherein the mounting bracket extends between the first end bracket and the second end bracket.

4. The rack bar assembly of claim 1, wherein the mounting bracket is supported by the first rack bar and the second rack bar through the first end bracket and the second end bracket.

5. The rack bar assembly of claim 1, wherein the mounting bracket includes a first bracket leg and a second bracket leg.

6. The rack bar assembly of claim 5, wherein the first bracket leg and the second bracket leg are angled relative to each other.

7. The rack bar assembly of claim 1, wherein the tie rod mounting features located inwardly relative to end locations of the first rack bar and the second rack bar.

8. The rack bar assembly of claim 2, wherein the mounting bracket is positioned externally of the housing and is coupled to the first end bracket and the second end bracket.

9. A rack bar assembly for a rack electric power steering system, the rack bar assembly comprising:
a first rack bar extending axially;
a second rack bar extending axially, wherein the first rack bar and the second rack bar are spaced a radial distance from each other and oriented parallel to each other; and
a mounting bracket directly coupled to at least one of the first rack bar and the second rack bar, wherein the mounting bracket includes a pair of tie rod mounting locations.

10. The rack bar assembly of claim 9, further comprising a housing containing at least a portion of the first rack bar and at least a portion of the second rack bar, the housing maintaining the radial distance between the first rack bar and the second rack bar.

11. The rack bar assembly of claim 9, further comprising:
a first end bracket coupled to at least one of the first rack bar and the second rack bar adjacent a first axial end region of the rack bar assembly; and
a second end bracket coupled to at least one of the first rack bar and the second rack bar adjacent an opposite axial end region of the rack bar assembly, wherein the mounting bracket extends between the first end bracket and the second end bracket.

12. The rack bar assembly of claim 9, further comprising a first end bracket and a second end bracket, wherein the mounting bracket is coupled to the first end bracket and the second end bracket.

13. The rack bar assembly of claim 9, wherein the mounting bracket includes a first bracket leg and a second bracket leg.

14. The rack bar assembly of claim 13, wherein the first bracket leg and the second bracket leg are angled relative to each other.

15. The rack bar assembly of claim 9, wherein the tie rod mounting features located inwardly relative to end locations of the first rack bar and the second rack bar.
